(19) United States
(12) Patent Application Publication
(10) Pub. No.: US 2023/0179657 A1
(43) Pub. Date: Jun. 8, 2023

(54) STORAGE MANAGEMENT SYSTEM AND STORAGE SYSTEM MANAGEMENT METHOD

(71) Applicant: Hitachi, Ltd., Tokyo (JP)

(72) Inventor: Hiroki YOSHIDA, Tokyo (JP)

(73) Assignee: Hitachi, Ltd., Tokyo (JP)

(21) Appl. No.: 17/940,316

(22) Filed: Sep. 8, 2022

(30) Foreign Application Priority Data
Dec. 6, 2021 (JP) 2021-197628

(51) Int. Cl. H04L 67/1097

(52) U.S. Cl. CPC H04L 67/1097

(57) ABSTRACT

A storage management system includes: a storage system including a plurality of server devices including a first communication device with a first communication network and a monitoring device including a second communication device with a second communication network, the storage system distributing and storing data; and a management device configured to receive destination information on the second communication device from the monitoring device via the second communication network, receive, based on the received destination information, individual information of the first communication device of the server device from the monitoring device of the server device via the second communication network, estimate destination information on the first communication device on the first communication network based on the received individual information of the first communication device, and transmit the estimated destination information on the first communication device to the first communication device of the server device via the first communication network.

### CROSS-REFERENCE TO RELATED APPLICATION

This application claims priority pursuant to Japanese patent application No. 2021-197628, filed on Dec. 6, 2021, the entire disclosure of which is incorporated herein by reference.

### BACKGROUND

### Technical Field

The present disclosure relates to a storage management system and a storage system management method.

### Related Art

A cluster system of file storage is built using a plurality of virtual disks and the like to provide data load balancing storage, which is implemented with increased redundancy. For example, Japanese Patent Application Publication No. 2014-38610 discloses a method for building a cluster system having a configuration in which at least one worker node of the cluster system is started in advance via a network using a master node of the cluster system, then a system kernel and a system image file are transmitted, a random access storage device is allocated to the worker node to form a virtual disk in which the system image file is to be temporarily stored, meanwhile, the system kernel is executed, the corresponding system image file is installed, and then a registration signal is transmitted to the master node to request the master node for an environment setting file, so that the setting of related services and the OS installation are completed by self-setting.

In order to provide a plurality of nodes with disk areas in this way, it is necessary to allocate and set the destination for access to each node, for example, an IP address in advance. Typically, such a setting needs an administrator or the like to perform manual allocation. Accordingly, an increased number of nodes in the cluster system results in an increase in man-hours for setting of the administrator and the like, and needs the administrator to know such set IP addresses, so that the risk of setting failure also increases.

### SUMMARY

The present disclosure has been made in view of such circumstances, and an objective thereof is to provide a storage management system capable of quickly and easily making settings for storage clustering, and a storage system management method.

An aspect of the present disclosure to solve the above objective is a storage management system comprising: a storage system including a plurality of server devices including a first communication device configured to perform communication through a first communication network and a monitoring device including a second communication device configured to perform communication through a second communication network, data being distributed and stored on each of the plurality of server devices via the first communication network; and a management device comprising a destination information acquisition unit configured to receive destination information on the second communication device from the monitoring device via the second communication network, an individual information acquisition unit configured to receive, based on the received destination information on the second communication device, individual information of the first communication device of the server device from the monitoring device of the server device via the second communication network, a destination information estimation unit configured to estimate, based on the received individual information of the first communication device, destination information on the first communication device, used for data communication through the first communication network, and a clustering information transmission unit configured to transmit the estimated destination information on the first communication device to the first communication device of the server device via the first communication network.

A further aspect of the present disclosure to solve the above objective is a storage system management method performed by an information processing device, the method comprising: a destination information acquisition process of receiving destination information on a second communication device from a monitoring device of a storage system via a second communication network, the storage system including a plurality of server devices including a first communication device configured to perform communication through a first communication network and the monitoring device including the second communication device configured to perform communication through the second communication network, data being distributed and stored on each of the plurality of server devices via the first communication network; an individual information acquisition process of receiving, based on the received destination information on the second communication device, individual information of the first communication device of the server device from the monitoring device of the server device via the second communication network; a destination information estimation process of estimating, based on the received individual information of the first communication device, destination information on the first communication device, used for data communication through the first communication network; and a clustering information transmission process of transmitting the estimated destination information on the first communication device to the first communication device of the server device via the first communication network.

### Advantageous Effects of Invention

According to the present disclosure, it is possible to quickly and easily make settings for storage clustering.

Problems, configurations, and effects other than those described above will be apparent from the following description of embodiments.

### BRIEF DESCRIPTION OF DRAWINGS

FIG. 1 is a diagram illustrating an example of a general configuration of a storage management system 1 according to an embodiment;

FIG. 2 is a diagram for explaining an example of functions of a management device;

FIG. 3 is a diagram for explaining an example of functional units (software) of a storage device;

FIG. 4 is a diagram illustrating an example of hardware (excluding a communication device) of an information processing device serving each of the storage device and the management device;

FIG. 5 is a sequence diagram for explaining the outline of a clustering process;

FIG. 6 illustrates an example of a monitoring device management table;

FIG. 7 illustrates an example of a host management table;

FIG. 8 is a flow chart for explaining an example of a cluster building process;

FIG. 9 is a flow chart for explaining the details of an IP address acquisition process;

FIG. 10 illustrates an example of a request to collect IPv6 addresses;

FIG. 11 illustrates an example of result information received by the management device;

FIG. 12 illustrates an example of a request to acquire a mac address;

FIG. 13 illustrates an example of result information received by the management device;

FIG. 14 is a flow chart for explaining the details of a host installation process;

FIG. 15 is a flow chart for explaining the details of a storage installation process;

FIG. 16 is a flow chart for explaining the details of a clustering execution process; and

FIG. 17 is a flow chart illustrating an example of a conventional method for building clustering.

### DETAILED DESCRIPTION OF EMBODIMENTS

Hereinafter, embodiments of the present disclosure will be described with reference to the drawings.

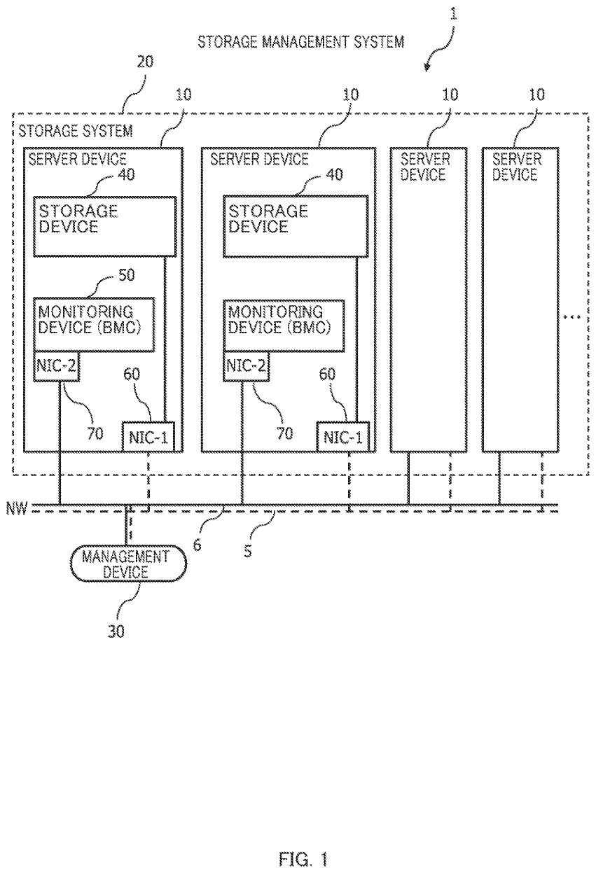

FIG. 1 is a diagram illustrating an example of a general configuration of a storage management system 1 according to an embodiment. The storage management system 1 includes a storage system 20 including a plurality of server devices 10 and includes a management device 30 that makes settings for clustering implemented by the storage system 20.

Each of the server devices 10 of the storage system 20 includes a storage device 40 that stores data and controls data storage, and a monitoring device 50 that monitors components (the details of which will be described later) included in the server device 10, acquires information, or the like.

The storage device 40 includes a first communication device 60, and is communicably connected to (the first communication device 60 of) another server device 10 through a first communication network 5. The server devices 10 implement clustering in which data is distributed over and stored in the server devices 10 by a predetermined allocation method or redundancy method.

The monitoring device 50 includes a second communication device 70, and is communicably connected to (the second communication device 70 of) another monitoring device 50 through a second communication network 6 different from the first communication network 5. In the present embodiment, the monitoring device 50 is a control chip (physical chip, for example, a baseboard management controller (BMC) such as integrated Lights-Out (iLO)). The monitoring device 50 is informed of the operating state and operation of the corresponding server device 10, and for example, may be configured to monitor failure information on the hardware in the server device 10 and transmit the result to the management device 30 via the second communication network 6.

The first communication device 60 and the second communication device 70 are each composed of, for example, a network interface card (NIC), a wireless communication module, a Universal Serial Interface (USB) module, a serial communication module, or the like.

The first communication network 5 and the second communication network 6 are each a wired or wireless communication network such as the Internet, a local area network (LAN), a wide area network (WAN), or a dedicated line. The first communication network 5 and the second communication network 6 are independent of each other since they have different communication bands, adopt different communication methods, or are made up of physically different types of cables or the like.

The management device 30 is communicably connected to the storage devices 40 of the server devices 10 via the first communication network 5. The management device 30 transmits information for implementing clustering to each storage device 40.

The management device 30 is communicably connected to the monitoring devices 50 of the server devices 10 via the second communication network 6. The management device 30 transmits predetermined request information to the monitoring devices 50 of the server devices 10 to acquire information related to the monitoring devices 50 and the storage devices 40.

<Management Device>

Next, the details of the functions of the management device 30 will be described.

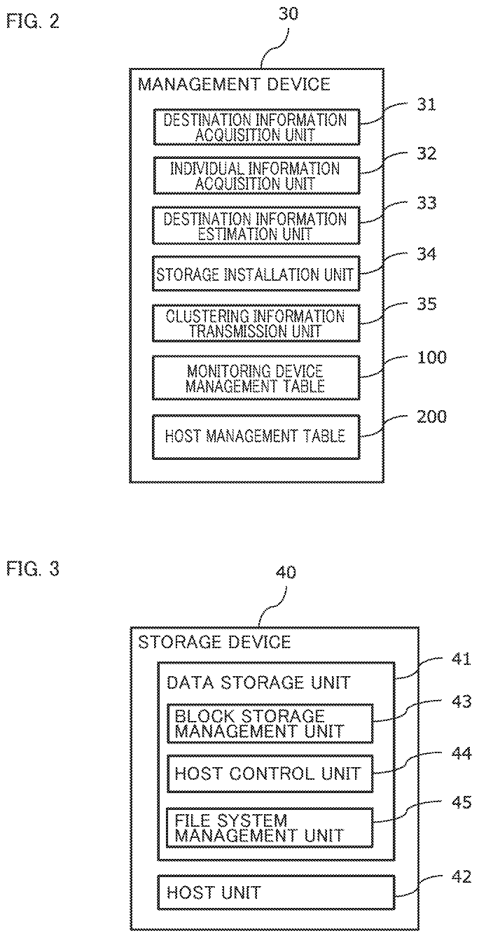

FIG. 2 is a diagram for explaining an example of the functions of the management device 30. The management device 30 includes functional units including a destination information acquisition unit 31, an individual information acquisition unit 32, a destination information estimation unit 33, a storage installation unit 34, and a clustering information transmission unit 35. The management device 30 also stores a monitoring device management table 100 and a host management table 200.

The destination information acquisition unit 31 receives destination information on the second communication device 70 from each monitoring device 50 via the second communication network 6.

This destination information is information for identifying the transmission destination (and the transmission source) of data for communication through the first communication network 5. In the present embodiment, the destination information acquisition unit 31 receives the IPv6 address of the second communication device 70 as the destination information. Further, in the present embodiment, the monitoring device 50 of each node holds the information on its own IPv6 address (information on the IPv6 address of its own second communication device 70) in advance by the function of the above-mentioned BMC, and performs a communication with the management device 30 by using that information.

The individual information acquisition unit 32 receives, based on the destination information (iPv6 address) on the second communication device 70 received by the destination information acquisition unit 31, the individual information of the first communication device 60 of the server device 10 from the monitoring device 50 of that server device 10 via the second communication network 6.

The individual information of the first communication device 60 is information for identifying the individual of the first communication device 60. In the present embodiment, the individual information acquisition unit 32 receives the mac address of the first communication device 60 as the individual information of the first communication device 60.

The destination information estimation unit 33 estimates, based on the individual information (mac address) of the first communication device 60 received by the individual information acquisition unit 32, the destination information (IPv6 address) on the first communication device 60, used for data communication through the first communication network 5.

The storage installation unit 34 installs a data storage area (file storage) on the storage device 40.

The clustering information transmission unit 35 transmits a clustering execution instruction including the destination information (IPv6 address) on the first communication device 60 for data communication through the first communication network 5, which has been estimated by the destination information estimation unit 33, to the first communication device 60 of the server device 10 via the first communication network 5.

This destination information is information on the destination required for the storage device 40 to perform data communication related to clustering.

<Storage Device>

FIG. 3 is a diagram for explaining an example of functional units (program) of the storage device. The storage device 40 includes a data storage unit 41 and a host unit 42.

The data storage unit 41 builds clustering on the server devices 10 to provide a file storage (storage system 20) capable of scale-out. Specifically, the data storage unit 41 includes components including a block storage management unit 43 that implements a block storage that stores data on a block basis, a host control unit 44 that controls the host unit 42, and a file system management unit 45 that manages a file system. These components of the data storage unit 41 may be configured as, for example, virtual machines.

The host unit 42 is a component provided for building the data storage unit 41. The host unit 42 is a hypervisor for building and executing each component (virtual machine) of the data storage unit 41.

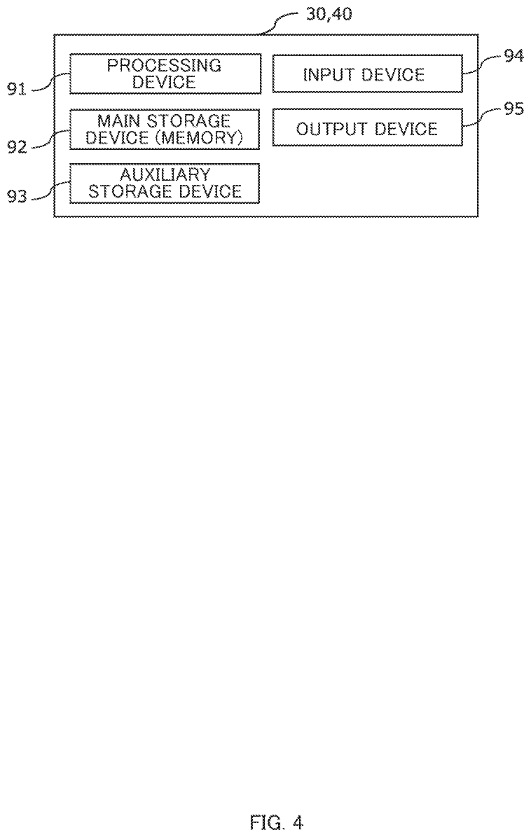

FIG. 4 is a diagram illustrating an example of hardware (excluding the communication device) of an information processing device each serving the storage device 40 and the management device 30. Each information processing device includes a processing device 91 such as a central processing unit (CPU), a digital signal processor (DSP), a graphics processing unit (GPU), and a field-programmable gate array (FPGA); a main storage device 92 such as a read only memory (ROM) and a random access memory (RAM); an auxiliary storage device 93 such as a hard disk drive (HDD) and a solid state drive (SSD); an input device 94 including a mouse, a keyboard, and the like; and an output device 95 including a liquid crystal display, an organic electro-luminescence (EL) display, or the like.

Each function of each information processing device is implemented by the processing device 91 reading and executing a program stored in the main storage device 92 or the auxiliary storage device 93. The above-described program can be recorded on a recording medium to be distributed, for example. All or part of each information processing device may be implemented using a virtual information processing resource to be provided by using virtualization technology, process space separation technology, or the like, for example, a virtual server provided by a cloud system. All or part of the functions provided by each information processing device may be implemented by, for example, a service provided by a cloud system through an application programming interface (API) or the like.

Next, the outline of a process performed by the storage management system 1 will be described.

<Outline of Process>

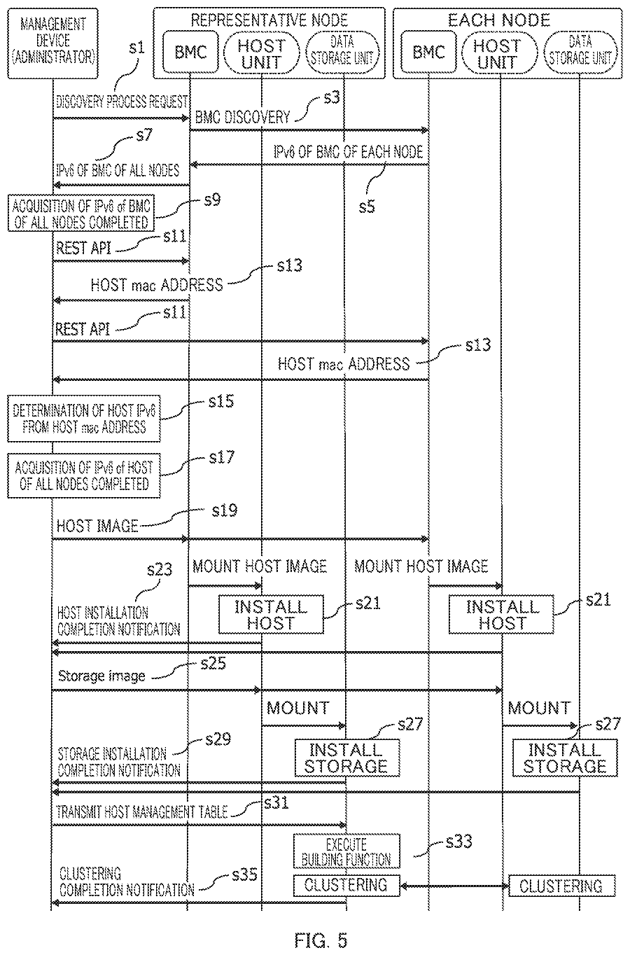

FIG. 5 is a sequence diagram for explaining the outline of the execution of clustering on the server device 10 and a process for the clustering (hereinafter referred to as a clustering process), which are performed by the storage management system 1.

First, the management device 30 receives the input of the IPv6 address of the monitoring device 50 of a representative node among the server devices 10 (hereinafter, also referred to as nodes), which is a node in which the IPv6 address of the monitoring device 50 is designated or grasped in advance by the administrator or the like.

Then, the management device 30 transmits a request to collect IPv6 addresses to the monitoring device 50 of the representative node via the second communication network 6 (s1).

When receiving the request to collect IPv6 addresses, the monitoring device 50 of the representative node transmits a request to acquire information on the IPv6 address (for example, an iLO discovery request) to the monitoring device 50 of each of the nodes other than the representative node via the second communication network 6 (s3).

When having received the discovery request, the monitoring device 50 of each node acquires information on its own IPv6 address (information on the IPv6 address of its own second communication device 70), and transmits the acquired information to the monitoring device 50 of the representative node via the second communication network 6 (s5).

When receiving the information on the IPv6 address from the monitoring device 50 of each node, the monitoring device 50 of the representative node transmits the received information on the IPv6 address to the management device 30 via the second communication network 6 (s7). Then, the management device 30 receives the information on the IPv6 addresses of the monitoring devices 50 of all the nodes and stores it in the monitoring device management table 100 (s9).

(Monitoring Device Management Table)

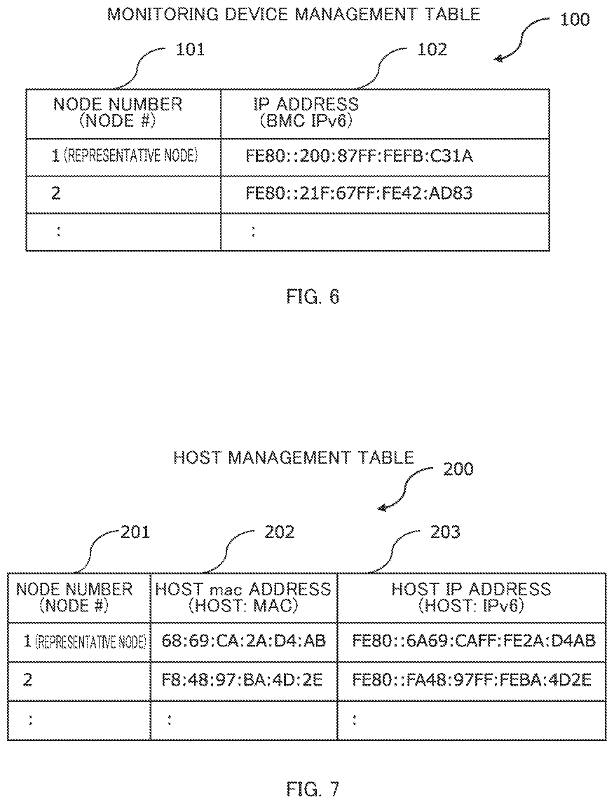

FIG. 6 illustrates an example of the monitoring device management table 100. The monitoring device management table 100 is composed of one or more records each having data items of a node number 101 and an IP address 102. A number (hereinafter referred to as a node number) assigned in advance to each server device 10 (node) is set in the node number 101. The IPv6 address of (the second communication device 70 of) the monitoring device 50 of the server device 10 associated with the node number 101 is set in the IP address 102.

Next, as illustrated in s11 of FIG. 5, the management device 30 transmits, to each of the monitoring devices 50 of all the nodes via the second communication network 6, a request to acquire the mac address of (the first communication device 60 of) the storage device 40 of the node to which that monitoring device 50 belongs (s11). In the present embodiment, the management device 30 transmits a request to acquire a mac address in order to call a REST API (Representational. State Transfer Application Programming Interface). Specifically, the management device 30 calls the REST API by transmitting a predetermined URL representing a request to acquire a mac address and an HTTP method to the monitoring device 50.

When having received the request to acquire the mac address, the monitoring device 50 of each node acquires the mac address of (the first communication device 60 of) the storage device 40 of that node. Then, the monitoring device 50 of each node transmits the acquired mac address to the management device 30 via the second communication network 6 (s13).

The management device 30 estimates the IPv6 address of the storage device 40 of each node based on the mac address of the storage device 40 of each node, and stores the estimated IPv6 address in the host management table 200 (s15, s17).

(Host Management Table)

FIG. 7 illustrates an example of the host management table 200. The host management table 200 is composed of one or more records each having data items of a node number 201, a host mac address 202, and a host IP address 203. A node number of one of the nodes including the representative node is set in the node number 201. The mac address of the first communication device 60 of the node monitoring device 50 associated with the node number 201 is set in the host mac address 202. The IPv6 address of the first communication device 60 of the storage device 40 of the node associated with the node number 201 is set in the host 1P address 203.

Next, as illustrated in s19 of FIG. 5, the management device 30 transmits a data image corresponding to the host unit 42 of the storage device 40 (a virtual drive image) to the monitoring device 50 of each node via the second communication network 6. The monitoring device 50 mounts the image as a virtual drive for the monitoring device 50 (for example, iLO).

After that, the storage device 40 installs each component (virtual machine) with the data image (s21).

When the installation of the component corresponding to the host unit 42 is completed, the storage device 40 of each node transmits a predetermined completion notification to the management device 30 via the second communication network 6 (s23).

Next, when receiving the completion notifications from all the nodes, the management device 30 transmits, to the storage device 40 of each node via the first communication network 5, a data image corresponding to the data storage unit 41 (a virtual drive image). The host unit 42 of the storage device 40 mounts the image as a virtual drive for the monitoring device 50 (for example, iLO) (s25).

After that, the storage device 40 installs each component (virtual machine) with the data image (s27).

When the installation of the component corresponding to the data storage unit 41 is completed, the storage device 40 of each node transmits a predetermined completion notification to the management device 30 via the second communication network 6 (s29).

Next, when receiving the completion notifications from all the nodes, the management device 30 transmits the host management table 200 to the storage device 40 of the representative node via the first communication network 5 (s31).

The data storage unit 41 of the storage device 40 of the representative node identifies the IPv6 address of each of the other storage devices 40 based on the received host management table 200. Then, the storage device 40 of the representative node performs, based on each of the identified IPv6 addresses, a predetermined communication with each of the other storage devices 40 through the first communication network 5, and executes clustering (s33).

When the clustering is completed, the storage device 40 of the representative node transmits a clustering completion notification to the management device 30 (s35). In response to receiving this completion notification, the management device 30 stores the completion of clustering.

Next, the details of a process performed by the management device 30 will be described.

<Cluster Building Process>

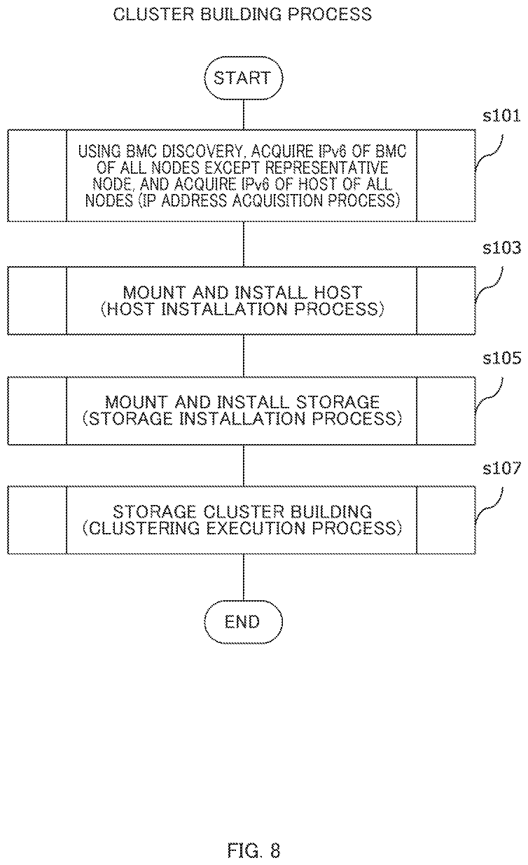

FIG. 8 is a flow chart for explaining an example of a process (cluster building process) performed by the management device 30 in the clustering process. First, the management device 30 executes an IP address acquisition process s101 for acquiring the IPv6 addresses of the monitoring devices 50 of all the nodes excluding the representative node, and the IPv6 addresses of the storage devices 40 of all the nodes (corresponding to s1 to s17 in FIG. 5).

Then, the management device 30 executes a host installation process s103 for installing the host unit 42 on the storage device 40 of each node based on the IPv6 addresses acquired in the IP address acquisition process s101 (corresponding to s19 to s23).

Further, the management device 30 executes a storage installation process s105 for causing the host unit 42 of each node built by the host installation process s103 to install the data storage unit 41 (corresponding to s25 to s29).

The management device 30 executes a clustering execution process s107 for causing the data storage unit 41 installed by the storage installation process s105 to execute clustering (corresponding to s31 to s35). This completes the cluster building process.

(IP Address Acquisition Process)

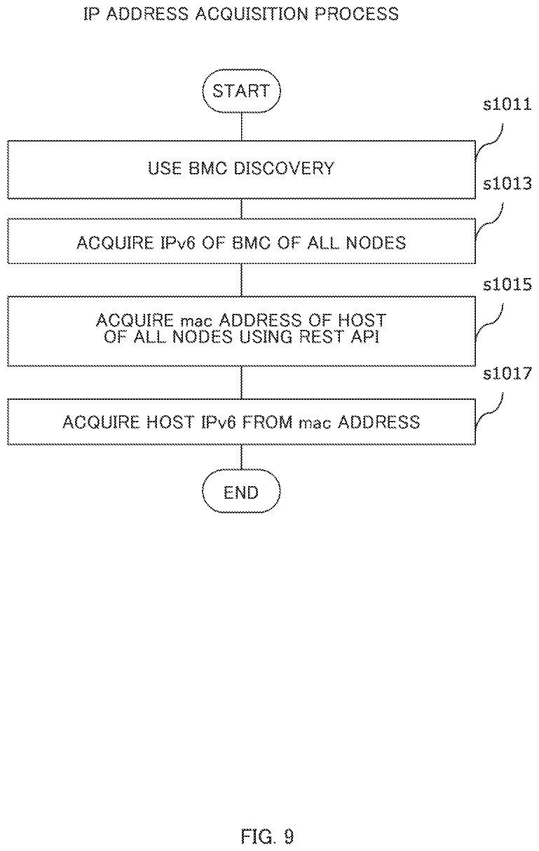

FIG. 9 is a flow chart for explaining the details of the IP address acquisition process s101 in FIG. 8.

First, the destination information acquisition unit 31 of the management device 30 requests the representative node for a discovery (s1011).

Specifically, first, the destination information acquisition unit 31 displays a predetermined input screen and receives the input of the IPv6 address of the monitoring device 50 of the representative node from the administrator. Then, the destination information acquisition unit 31 transmits a request to collect IPv6 addresses (of the nodes other than the representative node) (for example, an iLO discovery request) to the monitoring device 50 of the representative node by using the input IPv6 address as the destination. When receiving the request to collect IPv6 addresses, the monitoring device 50 of the representative node transmits a predetermined information acquisition request to the monitoring device 50 of each of the other nodes through multicast communication on the second communication network 6. When having received the information acquisition request, the monitoring device 50 of each node acquires the IPv6 address of the second communication device 70 of the storage device 40 and transmits it to the monitoring device 50 of the representative node. The monitoring device 50 of the representative node receives the IPv6 address from each of the other nodes.

The destination information acquisition unit 31 may explicitly set a group of monitoring devices 50 that are to perform multicast communication prior to this process.

Next, the destination information acquisition unit 31 acquires the IPv6 addresses of all the nodes (excluding the representative node) from the monitoring device 50 of the representative node (s1013). Specifically, the monitoring device 50 of the representative node transmits the IPv6 addresses of the monitoring devices 50 received from the other nodes to the management device 30. The destination information acquisition unit 31 receives predetermined result information including these IPv6 addresses.

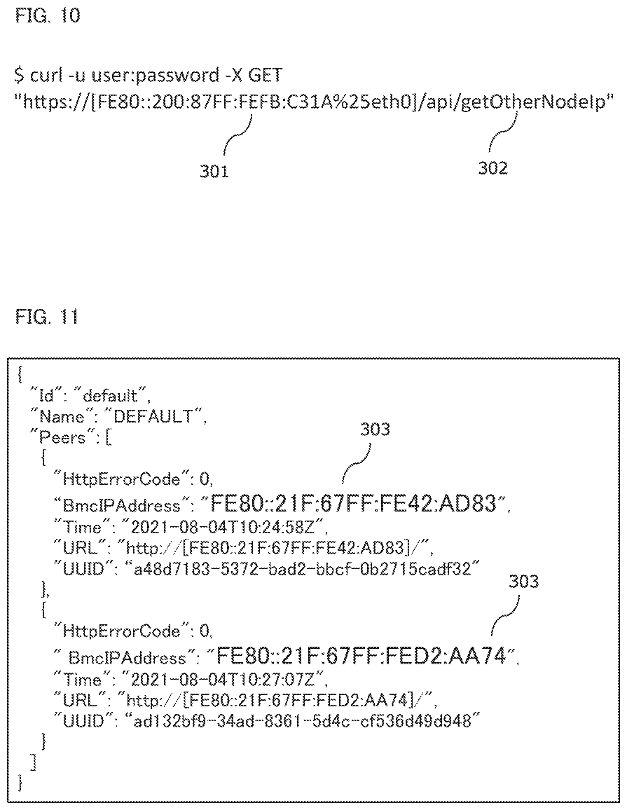

FIG. 10 illustrates an example of the request to collect IPv6 addresses (for example, an iLO discovery request). This request to collect IPv6 addresses has a designation part 301 for the IPv6 address of the monitoring device 50 of the representative node and a collection command part 302 for IPv6 addresses (designation of nodes other than the representative node).

FIG. 11 illustrates an example of result information received by the management device 30. This result information includes information 303 on the IPv6 address of each node.

Next, as illustrated in s1015 of FIG. 9, the individual information acquisition unit 32 acquires the mac addresses from the storage devices 40 of all the nodes.

Specifically, the individual information acquisition unit 32 uses the IPv6 addresses of the monitoring devices 50 acquired in s1013 as destinations, and calls the REST API by transmitting a request to acquire a mac address to the monitoring device 50 of each node. When receiving the request to acquire a mac address, the monitoring device 50 of each node acquires the mac address of the second communication device 70, and transmits predetermined result information including the acquired mac address to the management device 30. The individual information acquisition unit 32 receives the result information from each node.

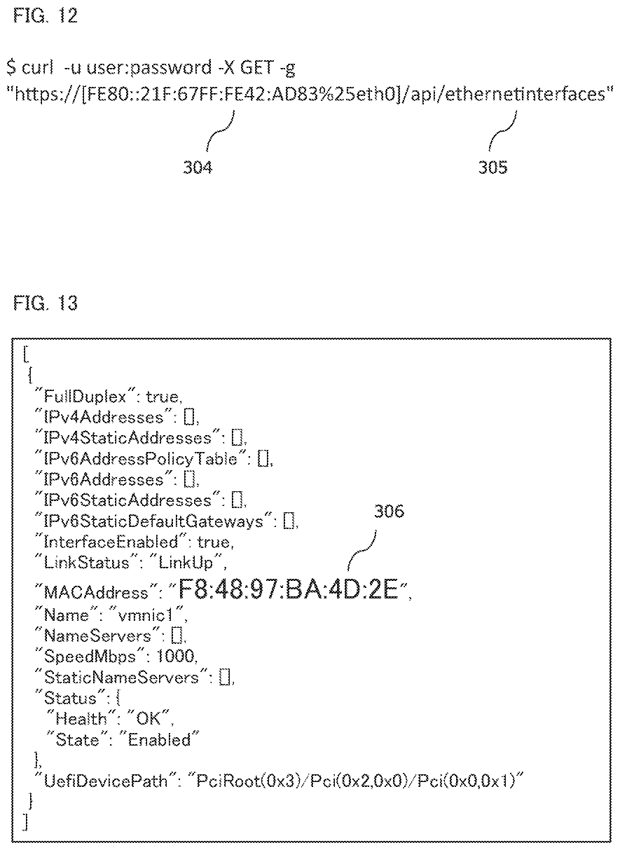

FIG. 12 illustrates an example of the request to acquire a mac address for calling the REST API. This request to acquire a mac address has a designation part 304 for the IPv6 address of the monitoring device 50 of the node and an acquisition command part 305 for the mac address.

FIG. 13 illustrates an example of result information received by the management device 30. This result information has information 306 on the mac address of the first communication device 60 of the node.

Next, as illustrated in s1017 of FIG. 9, the destination information estimation unit 33 estimates, based on the mac addresses of the first communication devices 60 of the nodes, which are collected in s1015, the IPv6 address of the first communication device 60 of each node.

Specifically, the destination information estimation unit 33 processes each of the mac addresses to acquire the corresponding IPv6 address which is defined in a data format supported by the host unit 42. For example, the individual information acquisition unit 32 creates an IPv6 address by data extension in which a predetermined numerical value is added to the mac address to create data in the EUI-64 format. This completes the IP address acquisition process s101.

(Host Installation Process)

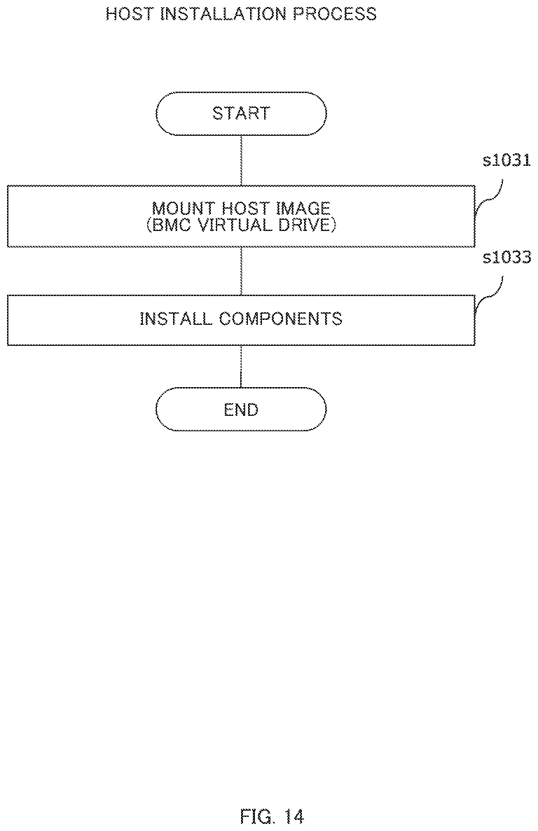

FIG. 14 is a flow chart for explaining the details of the host installation process s103 in FIG. 8. The storage installation unit 34 of the management device 30 instructs each node to mount and install a data image corresponding to the host unit 42 (s1031 and s1033).

Specifically, the storage installation unit 34 transmits a mount request in which a data image corresponding to the host unit 42 is designated to the monitoring device 50 of each node. When receiving the mount request, the monitoring device 50 of each node recognizes the data image designated in the mount request as a virtual drive. This data image may be stored in advance by the management device 30, or may be acquired by the management device 30 from another information processing device.

After that, the storage device 40 of each node installs each component (virtual machine) with the data image. This completes the host installation process s103.

(Storage Installation Process)

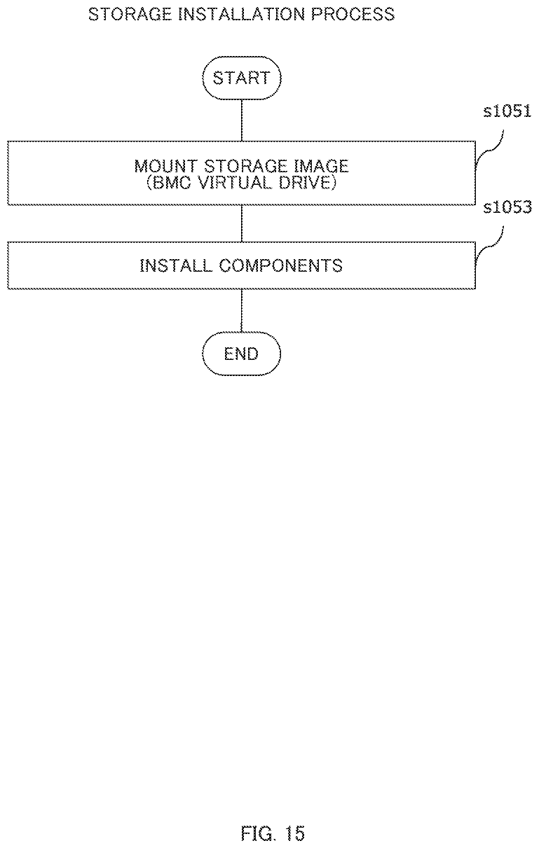

FIG. 15 is a flow chart for explaining the details of the storage installation process s105 in FIG. 8. The storage installation unit 34 instructs each node to mount the data storage unit 41 (s1051 and s1053).

Specifically, the storage installation unit 34 transmits, to the host unit 42 of the storage device 40 of each node, a mount request in which a data image corresponding to the data storage unit 41 of the node is designated. When receiving the mount request, the storage device 40 of each node recognizes the data image designated in the mount request as a virtual drive. This data image may be stored in advance by the management device 30, or may be acquired by the management device 30 from another information processing device.

After that, the storage device 40 of each node installs each component (virtual machine) with the data image. This completes the storage installation process s105.

(Clustering Execution Process)

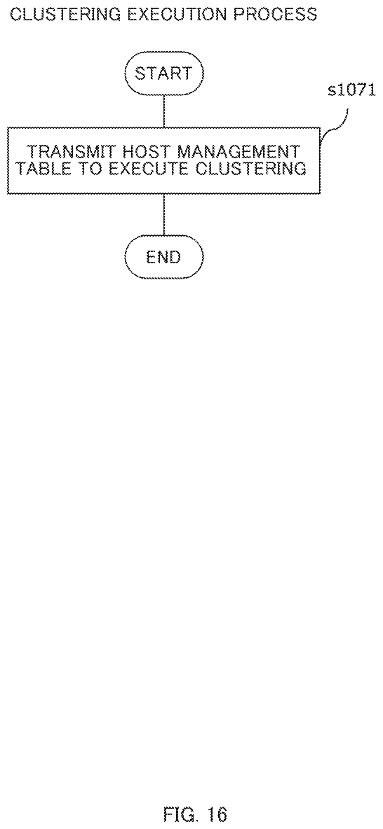

FIG. 16 is a flow chart for explaining the details of the clustering execution process s107 in FIG. 8. Specifically, the clustering information transmission unit 35 executes clustering for data on the storage devices 40 of the nodes (s1071).

Specifically, the clustering information transmission unit 35 transmits a clustering execution instruction including the host management table 200 to the storage device 40 of the representative node. When receiving the clustering execution instruction, the data storage unit 41 of the storage device 40 of the representative node acquires the IPv6 addresses of the first communication devices 60 of the storage devices 40 of the nodes, which are indicated by the respective host IP addresses 203 in the records of the host management table 200. The data storage unit 41 executes clustering by performing a predetermined data communication with the storage devices 40 indicated by the IPv6 addresses. This completes the clustering execution process s107.

As described above, a storage management system 1 of the present embodiment includes a plurality of server devices 10 each including a first communication device 60 configured to perform communication through a first communication network 5 and a monitoring device 50 (BMC) including a second communication device 70 configured to perform communication through a second communication network 6, and each of the server devices 10 receives, via the second communication network 6, destination information on the second communication device 70 from the monitoring device 50 in a storage system 20 configured to distribute and store data via the first communication network 5 by clustering, receives, based on the received destination information on the second communication device 70, individual information of the first communication device 60 of the server device 10 from the monitoring device 50 of the server device 10 via the second communication network 6, estimates destination information on the first communication device 60 based on the received individual information of the first communication device 60, and transmits the estimated destination information on the first communication device 60 to the first communication device 60 of the server device 10 via the first communication network 5.

In other words, the storage management system 1 receives the individual information of the first communication device 60 by using the monitoring device 50 that performs communication through the second communication network 6, and estimates, based on this individual information, the destination information on the first communication device 60 on the first communication network 5, which is necessary for clustering on the server devices 10. As a result, the storage management system 1 can build clustering on the plurality of server devices 10.

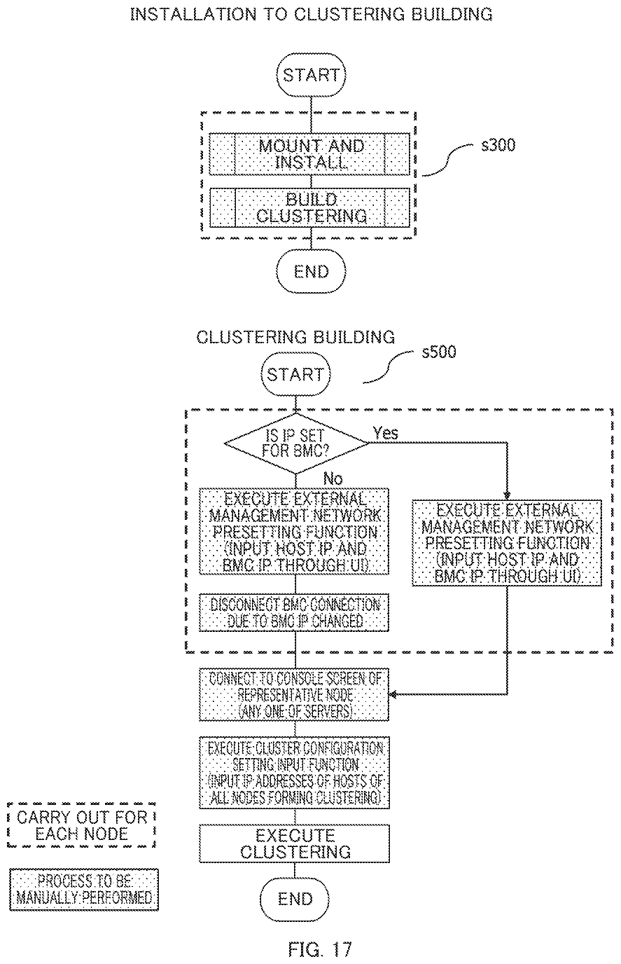

For example, FIG. 17 is a flow chart illustrating an example of a conventional method for building clustering. As illustrated in FIG. 17, in order to build clustering, the mount and installation of areas for the storage devices (nodes) are required to be performed as many as the number of nodes (s300), and in addition, the administrator is required to enter the IP addresses of the nodes in network settings (s501). In contrast, according to the storage management system 1 of the present embodiment, it is possible to acquire information necessary for executing clustering without making such settings for each node.

As described above, according to the storage management system 1 of the present embodiment, it is possible to quickly and easily make settings for storage clustering.

Further, in the present embodiment, the monitoring device 50 is a control chip (BMC such as iLO) that performs communication through the second communication network 6, which is a communication network independent of the first communication network 5, and the storage management system 1 receives the IPv6 address of the second communication device 70 as destination information on the second communication device 70 for communication on the first communication network 5 and also receives the mac address of the first communication device 60 as individual information of the first communication device 60.

In this way, by using the IPv6 address of the BMC and the mac address of the storage device 40, a highly versatile storage system can be configured.

Further, the storage management system 1 of the present embodiment transmits, to the designated monitoring device 50 (representative node), a request to acquire the destination information on the monitoring devices 50 of the nodes (iLO discovery request), which are other than the representative node, capable of communication through the first communication network 5, thereby receiving the destination information on the second communication devices 70 of the monitoring devices 50 of the other nodes on the first communication network 5.

In this way, even for the case where the storage system 20 is composed of a large number of nodes, using the discovery function of each monitoring device 50 makes it possible to acquire the destination information on the monitoring device 50 by a simple process.

Further, the storage management system 1 of the present embodiment transmits, to the monitoring devices 50 of the plurality of server devices through the second communication network 6, a request to acquire the individual information (mac address) of the first communication device 60 based on the received destination information on the second communication device 70 associated with each server device 10 on the first communication network 5 (REST API), thereby receiving the individual information of the first communication device 60 of each of the plurality of server devices 10.

In this way, by using the REST API, the individual information of the first communication device 60 of each server device 10 can easily be acquired.

Further, the storage management system 1 of the present embodiment transmits, to the first communication device 60 of the server device 10, a clustering execution instruction together with the destination information on the first communication device 60 estimated by the management device 30, and when having received the clustering execution instruction, the server device 10 executes clustering in which pieces of data of each of the plurality of server devices 10 are distributed and stored by performing mutual communication with the other server devices 10 based on the estimated destination information on the first communication device 60.

As a result, the storage system 20 can provide distribution and storage of data by clustering using the destination information on the first communication device 60 estimated by the management device 30.

The present disclosure is not limited to the above embodiments, and can be carried out by using any component without departing from the spirit and scope thereof. The embodiments and modifications described above are merely examples, and the present disclosure is not limited to their contents as long as the features of the disclosure are not impaired. Although various embodiments and modifications have been described above, the present disclosure is not limited to their contents. Other aspects considered within the scope of the technical idea of the present disclosure are also included within the scope of the present disclosure.

A part of each function provided in each device of the present embodiment may be provided in another device, or functions of different devices may be provided in one device.

A plurality of first communication devices 60 or second communication devices 70 may be provided for one server device 10. In this case, for example, in the monitoring device management table 100 and the host management table 200, a plurality of mac addresses or IP addresses are associated with a server device 10 having a certain node number.

### REFERENCE SIGNS LIST

1 Storage management system
5 First communication network
6 Second communication network
10 Server device
20 Storage system
30 Management device
31 Destination information acquisition unit
32 Individual information acquisition unit
33 Destination information estimation unit
35 Clustering information transmission unit
50 Monitoring device
60 First communication device
70 Second communication device

What is claimed is:

1. A storage management system comprising:
a storage system including a plurality of server devices including a first communication device configured to perform communication through a first communication network and a monitoring device including a second communication device configured to perform communication through a second communication network, data being distributed and stored on each of the plurality of server devices via the first communication network; and
a management device comprising
a destination information acquisition unit configured to receive destination information on the second communication device from the monitoring device via the second communication network,
an individual information acquisition unit configured to receive, based on the received destination information on the second communication device, individual information of the first communication device of the server device from the monitoring device of the server device via the second communication network,
a destination information estimation unit configured to estimate, based on the received individual information of the first communication device, destination information on the first communication device, used for data communication through the first communication network, and
a clustering information transmission unit configured to transmit the estimated destination information on the first communication device to the first communication device of the server device via the first communication network.

2. The storage management system according to claim 1, wherein
the monitoring device is a control chip that performs communication through the second communication network that is a communication network independent of the first communication network,
the destination information acquisition unit receives an IPv6 address of the second communication device as the destination information on the second communication device, and
the individual information acquisition unit receives a mac address of the first communication device as the individual information of the first communication device.

3. The storage management system according to claim 1, wherein the destination information acquisition unit transmits, to the monitoring device designated, a request to acquire destination information on another monitoring device other than the designated monitoring device, the other monitoring device being capable of communication through the first communication network, so as to receive the destination information on the second communication device of the other monitoring device.

4. The storage management system according to claim 1, wherein the individual information acquisition unit transmits a request to acquire the individual information of the first communication device based on the received destination information on the second communication device associated with each of the plurality of server devices to the monitoring devices of the plurality of server devices through the second communication network, so as to receive the individual information of the first communication device of each of the plurality of server devices.

5. The storage management system according to claim 1, wherein
the clustering information transmission unit transmits a clustering execution instruction together with the estimated destination information on the first communication device to the first communication device of the server device, and
when having received the clustering execution instruction, the server device executes clustering in which pieces of data of each of the plurality of server devices are distributed and stored by performing mutual communication with the other server devices based on the estimated destination information on the first communication device.

6. A storage system management method performed by an information processing device, the method comprising:
a destination information acquisition process of receiving destination information on a second communication device from a monitoring device of a storage system via a second communication network, the storage system including a plurality of server devices including a first communication device configured to perform communication through a first communication network and the monitoring device including the second communication device configured to perform communication through the second communication network, data being distributed and stored on each of the plurality of server devices via the first communication network;
an individual information acquisition process of receiving, based on the received destination information on the second communication device, individual information of the first communication device of the server device from the monitoring device of the server device via the second communication network;
a destination information estimation process of estimating, based on the received individual information of the first communication device, destination information on the first communication device, used for data communication through the first communication network; and
a clustering information transmission process of transmitting the estimated destination information on the first communication device to the first communication device of the server device via the first communication network.

7. The storage system management method according to claim 6, wherein
the monitoring device is a control chip that performs communication through the second communication network that is a communication network independent of the first communication network,
the destination information acquisition process performed by the information processing device includes receiving an IPv6 address of the second communication device as the destination information on the second communication device, and
the individual information acquisition process performed by the information processing device includes receiving a mac address of the first communication device as the individual information of the first communication device.

8. The storage system management method according to claim 6, wherein the destination information acquisition process performed by the information processing device includes transmitting, to the monitoring device designated, a request to acquire destination information on another monitoring device other than the designated monitoring device, the other monitoring device being capable of communication through the first communication network, so as to receive the destination information on the second communication device of the other monitoring device.

9. The storage system management method according to claim 6, wherein the individual information acquisition process performed by the information processing device includes transmitting a request to acquire the individual information of the first communication device based on the received destination information on the second communication device associated with each of the plurality of server devices to the monitoring devices of the plurality of server devices through the second communication network, so as to receive the individual information of the first communication device of each of the plurality of server devices.

10. The storage system management method according to claim 6, wherein
the clustering information transmission process performed by the information processing device includes transmitting a clustering execution instruction together with the estimated destination information on the first communication device to the first communication device of the server device, and
when having received the clustering execution instruction, the server device executes clustering in which pieces of data of each of the plurality of server devices are distributed and stored by performing mutual communication with the other server devices based on the estimated destination information on the first communication device.
